(19) United States
(12) Patent Application Publication
(10) Pub. No.: US 2016/0358691 A1
(43) Pub. Date: Dec. 8, 2016

(54) Cable Filling or Flooding Composition

(71) Applicant: MASTERCHEM SOLUTIONS, INC., Norcross, GA (US)

(72) Inventors: Nicholas C. Patterson, Hoschton, GA (US); Jerry J. Patterson, Ninety-Six, SC (US)

(21) Appl. No.: 14/420,277

(22) PCT Filed: Mar. 20, 2014
(86) PCT No.: PCT/US14/31313

§ 371 Date: Feb. 6, 2015

Related U.S. Application Data
(60) Provisional application No. 61/937,337, filed on Feb. 7, 2014.

(51) Int. Cl. H01B 7/285; C08L 57/02; H01B 3/22

(52) U.S. Cl. CPC H01B 7/285; H01B 3/22; C08L 57/02

(57) ABSTRACT

Technologies are disclosed herein for a fluidic composition used to fill or flood a cable, methods for manufacturing the compound, and cables using the composition. The fluidic composition includes a first oil, a second oil, fumed silica, and microspheres. Some formulations of the fluidic composition also include one or more antioxidants. The components of the composition may be blended at temperatures ranging from approximately 80 C to approximately 100 C. In one example, the cable is configured for vertical installations. In another example, the cable is configured or horizontal or non-vertical installations

### CROSS-REFERENCE TO RELATED APPLICATIONS

This application is a 371 of PCT/US2014/031313, entitled “Cable Filling or Flooding Composition” filed Mar. 20, 2014, which also claims priority to U.S. Provisional Patent Application No. 61/937,337 entitled “Low Density Cable Filling or Flooding Compound,” filed Feb. 7, 2014, which are incorporated herein by reference in their entireties.

### BACKGROUND

Materials which are placed around wires or fibers in cables to provide protection against water ingress are commonly referred to as filling or flooding compounds. A composition applied to a cable core is referred to as cable filler, while a composition applied between a core wrap and an outer protective casing or housing is referred to as cable flood. The function of both the filling and flooding compositions is to provide protection to the insulated wires in the cable core from water, which could seep in as a result of accidental damage to the outer casing of the cable. These compositions usually possess a number of properties that help to provide protection against water without adversely influencing transmission properties, often referred to as attenuation. The permissible range of these properties can be affected by cable design, manufacturing requirements, and the use of the cable.

It is with respect to these and other considerations that the disclosure made herein is presented.

### SUMMARY

A fluidic composition used to fill or flood a cable, methods for manufacturing the compound, and cables using the compound are described herein. The fluidic composition includes a first oil, a second oil, fumed silica, and microspheres. Some formulations of the fluidic composition also include one or more antioxidants.

According to one aspect described herein, a fluidic composition includes approximately 30% to approximately 90% volume percent of the first oil, approximately 10% to approximately 70% volume percent of the mixture as the second oil, approximately 1% to approximately 10% volume percent of the mixture fumed silica, and approximately 2.5% to approximately 5% volume percent of the mixture hollowed microspheres. Various examples of the fluidic composition may also include approximately 0.5% to approximately 1.5% volume percent of the mixture antioxidants.

According to another aspect described herein, a fluidic composition includes 30% to 90% volume percent of the first oil, 10% to 70% volume percent of the mixture as the second oil, 1% to 10% volume percent of the mixture fumed silica, and 2.5% to 5% volume percent of the mixture hollowed microspheres. Various examples of the fluidic composition may also include 0.5% to 1.5% volume percent of the mixture antioxidants.

According to another aspect described herein, the fluidic composition is created by blending in a first blending operation a first oil, a second oil, and an antioxidant in a blender at a temperature in the range of approximately 80 C to approximately 100 C. The mixture is blended for an amount of time to achieve a substantially or fully homogeneous mixture. In a second blending operation, fumed silica is added to the mixture resulting from the first blending operation and blended at a temperature in the range of approximately 80 C to approximately 100 C for approximately 15 to approximately 30 minutes.

In a third blending operation, microspheres are added to the mixture resulting from the second blending operation and blended at a temperature in the range of approximately 80 C to approximately 100 C. In some examples, the third blending operation is performed at a vacuum to remove air. In further examples, the fluidic composition resulting from the second blending operation is maintained at a temperature in the range of approximately 80 C to approximately 100 C prior to adding the microspheres.

According to a further aspect described herein, a cable is described having a filling or flooding compound that includes a synthetic or semi-synthetic oil having a volume percent in the composition in a range from approximately 30% to approximately 90%, polyisobutylene having a volume percent in the composition in a range from approximately 10% to approximately 70%, fumed silica having a volume percent in the composition in a range from approximately 1.0% to approximately 10.0%, at least one antioxidant having a volume percent in the composition in a range from approximately 0.5% to approximately 1.5%, and a plurality of microspheres having a volume percent in the composition in a range from approximately 2.5% to approximately 5.0%. In one example, the cable is configured for vertical installations. In another example, the cable is configured or horizontal or non-vertical installations.

According to an additional aspect, a cable filling or cable flooding composition is described. The cable filling or cable flooding composition comprises a synthetic or semi-synthetic oil having a volume percent in the composition in a range from approximately 55.5% to approximately 57.5%; polyisobutylene having a volume percent in the composition in a range from approximately 35.5% to approximately 37.5%; fumed silica having a volume percent in the composition in a range from approximately 1.0% to approximately 10.0%; at least one antioxidant having a volume percent in the composition in a range from approximately 0.5% to approximately 1.5%; and a plurality of microspheres having a volume percent in the composition in a range from approximately 2.5% to approximately 5.0%.

According to a further aspect described herein, a cable is described having a filling or flooding compound that includes a synthetic or semi-synthetic oil having a volume percent in the composition in a range from 30% to 90%, polyisobutylene having a volume percent in the composition in a range from 10% to 70%, fumed silica having a volume percent in the composition in a range from 1.0% to 10.0%, at least one antioxidant having a volume percent in the composition in a range from 0.5% to 1.5%, and a plurality of microspheres having a volume percent in the composition in a range from 2.5% to 5.0%. In one example, the cable is configured for vertical installations. In another example, the cable is configured or horizontal or non-vertical installations.

According to a still further aspect, a cable filling or cable flooding composition is described. The cable filling or cable flooding composition comprises a synthetic or semi-synthetic oil having a volume percent in the composition in a range from 55.5% to 57.5%; polyisobutylene having a volume percent in the composition in a range from 35.5% to 37.5%; fumed silica having a volume percent in the composition in a range from 1.0% to 10.0%; at least one antioxidant having a volume percent in the composition in a range from 0.5% to 1.5%; and a plurality of microspheres having a volume percent in the composition in a range from 2.5% to 5.0%.

These and various other features will be apparent from a reading of the following Detailed Description and a review of the associated drawings. This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram illustrating a cross-sectional view of an electrical cable according to an illustrative embodiment.

FIG. 2 is a flow diagram showing aspects of one illustrative routine for producing a fluidic composition according to an illustrative embodiment.

FIG. 3 is a diagram illustrating the use of a cable with an embodiment of the fluidic mixture in a vertical installation according to an illustrative embodiment.

### DETAILED DESCRIPTION

The following detailed description is directed inter alia to a cable filling or cable flooding composition, a method for making a cable filling or cable flooding composition, and a cable having a filling or flooding composition. As discussed briefly above and as described in detail below in various embodiments, the cable filling or cable flooding composition includes a first oil, a second oil, fumed silica, and microspheres. Some formulations of the fluidic composition also include one or more antioxidants.

While the subject matter described herein may be presented, at times, using specific chemicals or components, it should be noted that the disclosure provided herein may provide the information necessary for one of ordinary skill in the relevant art to determine one or more substitutes for the chemicals or components described herein, which are considered be within the scope of the present disclosure. It should be understood that the identification of specific chemicals or components is for descriptive and enablement purposes and is not an intent to limit the scope of the presently disclosed subject matter to the specific chemicals or components identified. Unless specified or indicated otherwise, the disclosure of a range between two endpoints, or approximately two end points, also includes all points between the two endpoints.

Several methods and compositions are described to detail various embodiments of the presently disclosed subject matter. It will be obvious to one skilled in the art that practicing the various embodiments does not require the employment of all or even some of the specific details outlined herein, but rather that concentrations, times and other specific details may be modified through routine experimentation. Unless otherwise defined, all technical and scientific terms used herein have the same meaning as commonly understood by one of ordinary skill in the art to which this presently disclosed subject matter belongs.

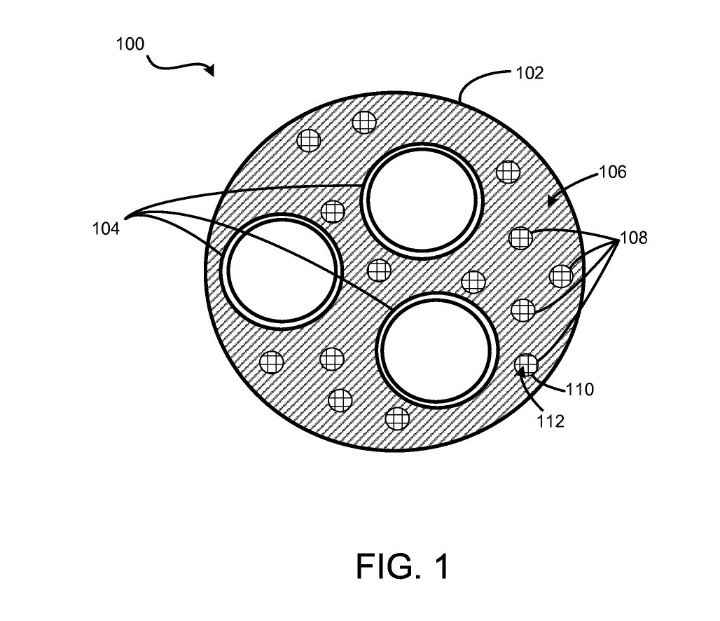

FIG. 1 is a diagram illustrating a cross-sectional view of a cable 100 according to an illustrative embodiment. The cable 100 includes an outer sheath 102 and one or more conductors 104 disposed within the outer sheath 102. The outer sheath 102 can be used to protect and insulate the conductors 104. The conductors 104 can include electrical, optic, or other types of electrical or electromagnetic, conductors. It should be understood that the cable 100 can include one or more components not illustrated. The presently disclosed subject matter is not limited to the cable 100 with only the conductors 104.

The sheath 102 can also be used to contain a fluidic composition 106. The fluidic composition 106 includes a first oil, a second oil, fumed silica, and microspheres. Some formulations of the fluidic composition also include one or more antioxidants. The fluid composition 106 can be used to protect the conductors 104 from water or other objects or components that may degrade the conductors 104 or the sheath 102. The fluidic composition 106 can be applied to a cable core, i.e. a cable filler, or applied between a core wrap and an outer protective casing or housing, i.e. a cable flood. Various configurations of the fluidic composition 106 may be used in either application.

The fluidic composition 106 can include approximately 30% to approximately 90% volume percent of the first oil, or in additional example, 30% to 90% volume percent of the first oil. The first oil can be a synthetic or semi-synthetic oil having a molecular weight in the range from approximately 500 to approximately 4800, or in an additional example, from 500 to 4800. “Synthetic oils” are man-made and tailored to have a controlled molecular structure with predictable properties. They are composed of organic and inorganic base stock oils combined with polymer packages to produce synthesized oil compounds, e.g. API/SAE Groups III, IV, and V.

One example of a synthetic oil that may be used as the first oil in some configurations in the presently disclosed subject matter are polyalphaolefinic oils that use olefinic oils as base stocks. A polyalphaolefin is an alkene where the carbon-carbon double bond starts at the α-carbon atom, i.e. the double bond is between the #1 and #2 carbons in the molecule. Examples of polyalphaolefinic oils are SYNFLUID 8 and mPAO40 by CHEVRON, based in California.

Another example of a synthetic oil that may be used as the first oil in some configurations of the presently disclosed subject matter are hydrocracked/hydroisomerized oils categorized as API/SAE Group II base oils. These oils can be formed by catalytic conversion of feed stocks under pressure in the presence of hydrogen. One example of a hydrocracked/hydroisomerized oil is a gas-to-liquid (GTL) oil. An example of GTL oil is RISSELA X 430 by SHELL, based in Texas. Various configurations of the presently disclosed subject matter may also use API Group V Esters

As mentioned above, the fluidic composition 106 can include synthetic or semi-synthetic oils, or combinations thereof. Semi-synthetic oils (also called are blends of mineral oil typically with less than 30% synthetic oil. Semi-synthetic oils are typically designed to have many of the benefits of synthetic oil but at a lower cost, without costing as much as a similar, pure synthetic oil.

The fluidic composition 106 can also include approximately 10% to approximately 70% volume percent of the mixture as the second oil, or in another example, 10% to 70% volume percent of the mixture as the second oil. In some examples, the second oil is polybutene or polyisobutylene (PIB) having molecular weights in a range approximately from 320 to approximately 2500. Polybutene can be made from fluidic catalytic cracking C4 olefins. PIB is usually produced from essentially pure isobutylene made in a C4 complex of a major refinery. A type of PIB that may be used is INDOPOL H-100 by INEOS OLIGOMERS, based in Switzerland.

The fluidic composition 106 can also include approximately 1% to approximately 10% volume percent of the mixture fumed silica, or in another example, 1% to 10% volume percent of the mixture fumed silica. The fluidic composition 106 can also include approximately 2.5% to approximately 5% volume percent of the mixture hollowed microspheres, or in another example, 2.5% to 5% volume percent of the mixture hollowed microspheres. A type of fumed silica that may be used is R-974 by EVONIK INDUSTRIES, based in Germany. The fumed silica may be hydrophobic, hydrophilic, or combinations thereof.

The fluidic composition 106 can also include approximately 0.5% to approximately 1.5% volume percent antioxidants, or in another example, 0.5% to 1.5% volume percent antioxidants. The volume percentages may be based on desired physical or chemical characteristics of the fluidic composition 106. Antioxidants that may be used in some examples of the presently disclosed subject matter are the IRGANOX 1076 and the 1010 antioxidants by BASF, based in Germany.

In some applications, it may be necessary for the fluidic composition 106 to meet certain density and/or viscosity requirements. For example, when used in some applications, the viscosity may need to be low enough to allow the fluidic composition 106 to be pumped into the cable 100, while high enough to reduce the amount of leakage or separation of one or more components out of the fluidic composition 106. The density may also need to be within certain requirements to provide for a fluid that can be readily pumped. In some examples, it may be difficult, or impossible, to pump a high density liquid into the cable 100 without the use of specially made pumps.

Thus, in some examples, the fluidic composition 106 includes hollowed microspheres 108, illustrated in FIG. 1 as crosshatched spheres within the fluidic composition 106. Along with other potential reasons, because of their hollow nature, the microspheres 108 may be used to achieve a certain density requirement for the fluidic composition 106. Along with the variation of other components, certain density and viscosity criteria may be achieved. A type of microsphere that may be used in some formulations of the presently disclosed subject is the DUALITE E030 provided by HENKEL, based in Greenville, S.C.

In some examples, the microspheres 108 have an inert coating. In some examples, the inert coating comprises acrylonitrile and methacrylonitrile. The microspheres 108 can be constructed to be partially or fully hollow, having only an inert outer shell 110. The outer shell 110 can define a void 112 within the microsphere. The outer shell 110 can be constructed to be partially or fully non-deformable. As used herein, “non-deformable” means that the shape of the outer shell remains relatively constant or does not deform under a pre-determined amount of pressures (such as the impact from the blade of a blender or an impeller of a pump). Preferable, the shell 110 of the microsphere 108 is of sufficient strength to withstand the pressures and forces experienced during the manufacture of the fluidic composition 106, the pumping of the fluidic composition 106 into the cable 100, and the use of the cable 100.

Some configurations of the fluidic composition 106 are physically thixotropic gels in which a three dimensional chicken-wire type network formed by the fumed silica traps the organic oil in the network cage. The fumed silica network is held together by hydrogen bonds, which exist between pairs of residual hydroxyl groups on the surfaces of the fumed silica particles. The hydrogen bonds act as weak crosslinks in the gel structure of the filling composition. When the gel structure is disrupted, the hydrogen bonds are broken and the gel flows. As the hydrogen bond density increases in the gel structure, the force required to cause the gel to flow increases. Thus, the greater the hydrogen bond density, the higher the critical yield stress. The filling composition may also contain small amounts of additional substances so as to increase the beneficial properties of the composition. For instance, small amounts of dyes, rust inhibitors, organic thickeners and surfactants can also be added.

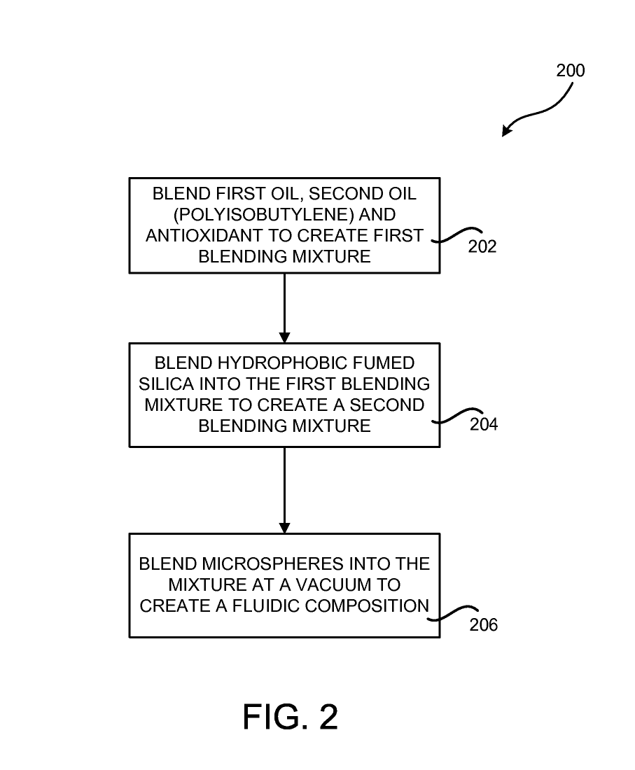

FIG. 2 is a flow diagram showing aspects of one illustrative routine for producing the fluidic composition 106 according to an illustrative embodiment. It should be appreciated that more or fewer operations may be performed than shown in the figures and described herein. Some operations may be performed in parallel, or, in a different order, than as described herein.

The routine 200 begins at operation 202, where in a first blending operation, high molecular weight oil, polybutene and an antioxidant are mixed in a blender at a temperature in the range approximately from 80 C to approximately 100 C to create a first blending mixture. The mixture is blended for an amount of time to achieve a substantially or fully homogeneous mixture. As discussed above, in some examples, it may not be desirable or needed to use antioxidants in the fluid composition 106. In those examples, the first blending operation may proceed without the addition of one or more antioxidants.

The routine 200 continues to operation 204, where in a second blending operation, fumed silica is added to the mixture resulting from the first blending operation and is blended at a temperature in the range from approximately 80 C to approximately 100 C for approximately 15 to approximately 30 minutes to create a second blending mixture. Various configurations of the fluidic composition 106 may be formed by mixing the components in a high shear mixer preferably equipped with a vacuum port. In one example, the mixer has the capability of varying the shear so as to obtain maximum dispersion of the fumed silica without over shearing the composition. In one example, fumed silica is added and slowly worked into the mixture in the second blending operation.

The routine 200 continues to operation 206, where in a third blending operation, microspheres are added to the mixture resulting from the second blending operation and blended at a temperature in the range from approximately 80 C to approximately 100 C. In some examples, the third blending operation is performed at a vacuum to remove air. In further examples, the fluidic composition resulting from the second blending operation is maintained at a temperature in the range from approximately 80 C to approximately 100 C prior to adding the microspheres. After a sufficient period of time, the fluidic composition 106 resulting from the third blending operation may be poured into a container or used directly to fill or flood a cable. The routine 200 thereafter ends.

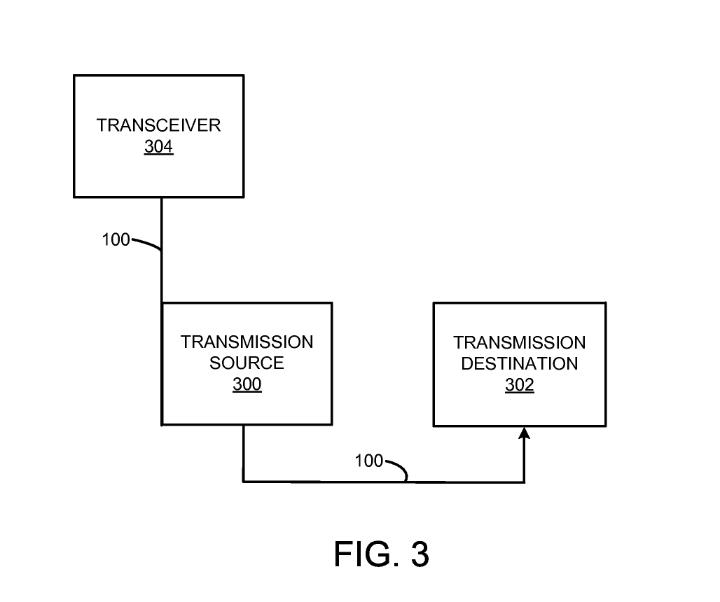

FIG. 3 is a diagram showing the use of the cable 100 having the fluidic composition 106 disposed therein in various applications. For example, the cable 100 may be used to electrically or optically connect a transmission source 300 to a transmission destination 302. In another example, the cable 100 may be used to carry signals from the transmission source 300 to a transceiver 304. The presently disclosed subject matter is not limited to any particular type of transmission, transmission source, transmission receiver, or vertical/horizontal alignment of the cable 100.

Various example formulations of the presently disclosed subject matter are described in Table 1, which is intended as illustrative only since numerous modifications and variations therein will be apparent to those skilled in the art. It should be understood that the formulations described below are merely exemplary, as formulations comprising components in volume percentages between, above or below the volume percentages indicated below may be used and are considered to be within the scope of the present disclosure.

In the following examples, viscosity was measured using a Brookfield HBT or HBDV-II CP cone and plate viscometer fitted with a CP 52 cone spindle. The viscometer system was stabilized with a circulating water bath @ 25 C. Using a volumetric syringe, 0.5 mL of void free material was injected onto the center of the bottom viscometer plate. The spindle speed was set to 10 RPM (20 sec-1) or 5 RPM (10 sec-1). The viscosity reading was recorded at a 10 minute shear time.

TABLE 1
Component Mixtures given in Volume %

| | A | B | C | D | E | F | G |
|---|---|---|---|---|---|---|---|
| First oil | 56.58 | 62.63 | 57.53 | 57.53 | 56.58 | 56.58 | 67.63 |
| Anti-oxidant #1 | 0.47 | 0.47 | 0.47 | 0.47 | 0.47 | 0.47 | 0.47 |
| Anti-oxidant #2 | 0.5 | 0.5 | 0.5 | 0.5 | 0.5 | 0.5 | 0.5 |
| Polybutene | 36.05 | 30 | 36.4 | 36.4 | 36.05 | 36.05 | 25 |
| Fumed Silica | 1.9 | 1.9 | 2.0 | 2.0 | 1.9 | 1.9 | 1.9 |
| Microspheres | 4.5 | 4.5 | 3.1 | 3.1 | 4.5 | 4.5 | 4.5 |

In Mixture A, the following materials were used: the first oil is CHEVRON mPAO 40; anti-oxidant #1 is IRGANOX 1076; anti-oxidant #2 is IRGANOX 1010; the second oil is polyisobutylene, H-100; fumed silica is R-974; and the microspheres are DUALITE E030. The formulation of Mixture A resulted in the following properties: density of 0.35 g/cm3; viscosity at 25 C and 10 rpm of 45,000 cps and at 5 rpm of 55,000 cps; and 0% oil separation in 24 hours at 100 C.

In Mixture B, the following materials were used: the first oil is a synthetic oil, CHEVRON mPAO 40; anti-oxidant #1 is IRGANOX 1076; anti-oxidant #2 is IRGANOX 1010; the second oil is polyisobutylene, H-100; fumed silica is R-974; and the microspheres are DUALITE E030. The formulation of Mixture B resulted in the following properties: density of 0.35 g/cm3; viscosity at 25 C and 10 rpm of 29,490 cps; and 0% oil separation in 24 hours at 100 C.

In Mixture C, the following materials were used: the first oil is a synthetic oil, CHEVRON mPAO 40; anti-oxidant #1 is IRGANOX 1076; anti-oxidant #2 is IRGANOX 1010; the second oil is polyisobutylene, H-100; fumed silica is R-974; and the microspheres are DUALITE E030. The formulation of Mixture C resulted in the following properties: density of 0.45 g/cm3; viscosity at 25 C and 10 rpm of 29,000 cps and at 5 rpm of 41,000 cps; and 0% oil separation in 24 hours at 100 C.

In Mixture D, the following materials were used: the first oil is a synthetic oil, CHEVRON mPAO 40; anti-oxidant #1 is IRGANOX 1076; anti-oxidant #2 is IRGANOX 1010; the second oil is polyisobutylene, H-100; fumed silica is R-972; and the microspheres are DUALITE E030. The formulation of Mixture D resulted in the following properties: density of 0.45 g/cm3; viscosity at 25 C and 10 rpm of 22,000 cps and at 5 rpm of 29,000 cps; and 0% oil separation in 24 hours at 100 C.

In Mixture E, the following materials were used: the first oil is a synthetic oil, SYNFLUID 8; anti-oxidant #1 is IRGANOX 1076; anti-oxidant #2 is IRGANOX 1010; the second oil is polyisobutylene, H-100; fumed silica is R-974; and the microspheres are DUALITE E030. The formulation of Mixture E resulted in the following properties: density of 0.35 g/cm3; viscosity at 25 C and 10 rpm of 17,610 cps; and 0% oil separation in 24 hours at 100 C.

In Mixture F, the following materials were used: the first oil is a GTL oil, RISSELA X 430; anti-oxidant #1 is IRGANOX 1076; anti-oxidant #2 is IRGANOX 1010; the second oil is polyisobutylene, H-100; fumed silica is R-974; and the microspheres are DUALITE E030. The formulation of Mixture F resulted in the following properties: density of 0.35 g/cm3; viscosity at 25 C and 10 rpm of 21,620 cps; and 0% oil separation in 24 hours at 100 C.

In Mixture G, the following materials were used: the first oil is a synthetic oil, CHEVRON mPAO 40; anti-oxidant #1 is IRGANOX 1076; anti-oxidant #2 is IRGANOX 1010; the second oil is polyisobutylene, H-100; fumed silica is R-974; and the microspheres are DUALITE E030. The formulation of Mixture G resulted in the following properties: density of 0.35 g/cm3; viscosity at 25 C and 10 rpm of 27,600 cps; and 0% oil separation in 24 hours at 100 C.

Other compositions may be used as well and are considered to be within the scope of the presently disclosed subject matter. For example, a formulation (given in volume %) may include the following for a density of approximately 0.35 g/cm3: polyalphaolefin oil from approximately 60% to approximately 70%, and from approximately 63% to approximately 64%, and in an example formulation, approximately 63.34%; polyisobutylene from approximately 28% to approximately 36%, and from approximately 31% to approximately 34%, and in a formulation, approximately 33%; anti-oxidant in an amount from approximately 0.1% to approximately 5%, and from approximately 0.4% to approximately 0.6%, and in an example formulation, 0.5%; hydrophilic silica from approximately 1% to approximately 6%, and from approximately 2% to approximately 5%, and in an example formulation, approximately 3.16%; and microspheres from approximately 2% to approximately 8%, and from approximately 4% to approximately 6%, and in an example formulation, approximately 5%.

In another example, a formulation may include the following for a density of approximately 0.45 g/cm3: polyalphaolefin oil from approximately 60% to approximately 70%, and from approximately 63% to approximately 64%, and in an example formulation, approximately 62.25%; polyisobutylene from approximately 28% to approximately 36%, and from approximately 31% to approximately 34%, and in a formulation, approximately 33%; anti-oxidant in an amount from approximately 0.1% to approximately 5%, and from approximately 0.4% to approximately 0.6%, and in an example formulation, 0.5%; hydrophilic silica from approximately 1% to approximately 6%, and from approximately 2% to approximately 5%, and in a n example formulation, approximately 4.0%; and microspheres from approximately 2% to approximately 8%, and from approximately 4% to approximately 6%, and in an example formulation, approximately 4.2%.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A cable filling or cable flooding composition, comprising:
a first oil;
a second oil;
fumed silica; and
a plurality of microspheres.

2. The cable filling or cable flooding composition of claim 1, wherein a volume percent of the first oil in the composition is in the range of approximately 30% to approximately 90%.

3. The cable filling or cable flooding composition of claim 1, wherein the first oil is a synthetic or semi-synthetic oil.

4. The cable filling or cable flooding composition of claim 1, wherein the first oil is a polyalphaolefinic oil or a gas-to-liquid oil.

5. The cable filling or cable flooding composition of claim 1, wherein the first oil has a molecular weight in a range approximately from 500 to approximately 4800.

6. The cable filling or cable flooding composition of claim 1, wherein a volume percent of the second oil in the composition is in the range from approximately 10% to approximately 70%.

7. The cable filling or cable flooding composition of claim 1, wherein the second oil is polybutene or polyisobutylene.

8. The cable filling or cable flooding composition of claim 1, wherein the second oil has a molecular weight in a range from approximately 320 to approximately 2500.

9. The cable filling or cable flooding composition of claim 1, wherein a volume percent of the fumed silica in the composition is in the range from approximately 1% to approximately 10%.

10. The cable filling or cable flooding composition of claim 1, wherein the fumed silica is hydrophobic, hydrophilic, or combinations thereof.

11. The cable filling or cable flooding composition of claim 1, wherein a volume percent of the microspheres in the composition is in the range from approximately 2.5% to approximately 5%.

12. The cable filling or cable flooding composition of claim 1, further comprising at least one antioxidant.

13. The cable filling or cable flooding composition of claim 12, wherein a volume percent of the at least one antioxidant in the composition is in the range from approximately 0.5% to approximately 1.5%.

14. A method for producing a fluidic composition for use as a cable filler or cable flood, the method comprising:
blending in a first blending operation a first oil, a second oil, and an antioxidant in a blender to create a first blending mixture;
adding fumed silica to the first blending mixture;
blending in a second blending operation the fumed silica and the first blending mixture to create a second blending mixture;
adding a plurality of microspheres to the second blending mixture; and
blending in a third blending operation the microspheres and the second blending mixture to create the a fluidic composition.

15. The method of claim 14, wherein the first blending operation, the second blending operation or the third blending operation are conducted at a temperature in the range from approximately 80 C to approximately 100 C.

16. The method of claim 14, wherein the third blending operation is performed at a vacuum to remove air.

17. The method of claim 14, wherein the first blending operation, the second blending operation or the third blending operation are conducted for a period of time to achieve a substantially homogenous mixture.

18. The method of claim 14, further comprising maintaining the temperature of the second blending mixture in the range from approximately 80 C to approximately 100 C while adding the plurality of microspheres.

19. The method of claim 14, wherein
a volume percent of the first oil in the composition is in the range from approximately 30% to approximately 90%;
a volume percent of the second oil in the composition is in the range from approximately 10% to approximately 70%;
a volume percent of the fumed silica in the composition is in the range from approximately 1% to approximately 10%;
a volume percent of the microspheres in the composition is in the range from approximately 2.5% to approximately 5%; and
a volume percent of the at least one antioxidant in the composition is in the range from approximately 0.5% to approximately 1.5%.

20. A cable filling or cable flooding composition, comprising:
a synthetic or semi-synthetic oil having a volume percent in the composition in a range from approximately 55.5 to approximately 57.5%;
polyisobutylene having a volume percent in the composition in a range from approximately 35.5% to approximately 37.5%;
fumed silica having a volume percent in the composition in a range from approximately 1.0% to approximately 10.0%;
at least one antioxidant having a volume percent in the composition in a range from approximately 0.5% to approximately 1.5%; and
a plurality of microspheres having a volume percent in the composition in a range from approximately 2.5% to approximately 5.0%.
